(19) United States
(12) Patent Application Publication
(10) Pub. No.: US 2016/0273488 A1
(43) Pub. Date: Sep. 22, 2016

(54) CASCADE VANE LEADING EDGE

(71) Applicant: Rohr, Inc., Chula Vista, CA (US)

(72) Inventors: Anthony Whitaker, San Diego, CA (US); Matthew Wen, Palo Alto, CA (US); Joshua Pritekel, San Diego, CA (US)

(21) Appl. No.: 14/663,169

(22) Filed: Mar. 19, 2015

(51) Int. Cl. F02K 1/64

(52) U.S. Cl. CPC F02K 1/64

(57) ABSTRACT

Aspects of the disclosure are directed to a cascade vane for an aircraft, comprising: a leading edge that is configured to interface to a fluid flow, where the leading edge is associated with a first thickness that is proximate to the fluid flow, and where the leading edge is associated with a second thickness that is further from the fluid flow than the first thickness, and where the first thickness is smaller than the second thickness such that the leading edge includes a distance associated with a blended profile between the first thickness and the second thickness.

### BACKGROUND

On an aircraft, a nacelle may be used to house an engine and a thrust reverser system. An example of a thrust reverser system 100 is shown in FIGS. 1A-1B. In FIG. 1A, the thrust reverser system 100 is in a first state corresponding to a stowed state, whereas in FIG. 1B the thrust reverser system 100 is in a second state corresponding to a deployed state.

When the thrust reverser system 100 is operated in the stowed state (FIG. 1A), a translating sleeve 102 shields a set of cascade vanes 104 from the ambient environment and a blocker door 106 is stowed, such that a bypass fan flow 108 is directed down a bypass channel 110 substantially unopposed.

When the thrust reverser system 100 is operated in the deployed state (FIG. 1B), the translating sleeve 102 has been translated (aft) relative to FIG. 1A to expose the cascade vanes 104 to the ambient environment. In FIG. 1B, the blocker door 106 is deployed such that the blocker door 106 resides within the channel 110, redirecting a substantial portion of the bypass fan flow 108 through the cascade vanes 104 and producing reverse thrust.

For completeness, a drag link 112 is shown. The drag link 112 may be used to retain the door 106 in position in the stowed state and aid in the deployment of the door 106 in transitioning from the stowed state to the deployed state.

The effectiveness or efficiency of the thrust reverser system 100 may be expressed as a ratio between (1) the actual or realized reverse thrust, and (2) an ideal or theoretical thrust. Non-idealities may result in a loss of efficiency. Techniques are needed to realize greater thrust reverser efficiency.

### BRIEF SUMMARY

The following presents a simplified summary in order to provide a basic understanding of some aspects of the disclosure. The summary is not an extensive overview of the disclosure. It is neither intended to identify key or critical elements of the disclosure nor to delineate the scope of the disclosure. The following summary merely presents some concepts of the disclosure in a simplified form as a prelude to the description below.

Aspects of the disclosure are directed to a thrust reverser system for an aircraft, comprising: a cascade vane having a first associated thickness and a second associated thickness, where the first thickness is substantially located at an end of the cascade vane that is proximate to a bypass fan flow, and where the first thickness is different from the second thickness such that the cascade vane includes a blended profile between the first thickness and the second thickness. In some embodiments, a distance of the blended profile is less than the second thickness. In some embodiments, a distance of the blended profile is greater than the second thickness and less than two times the second thickness. In some embodiments, a distance of the blended profile is greater than two times the second thickness. In some embodiments, the second thickness is located further from the bypass fan flow than the first thickness. In some embodiments, the first thickness is smaller than the second thickness.

Aspects of the disclosure are directed to a cascade vane for an aircraft, comprising: a leading edge that is configured to interface to a fluid flow, where the leading edge is associated with a first thickness that is proximate to the fluid flow, and where the leading edge is associated with a second thickness that is further from the fluid flow than the first thickness, and where the first thickness is smaller than the second thickness such that the leading edge includes a distance associated with a blended profile between the first thickness and the second thickness. In some embodiments, the fluid flow comprises a bypass fan flow. In some embodiments, the first thickness is measured between a first tangency and a second tangency, and a first location of the first tangency and a second location of the second tangency are based at least in part on a first shape of a first fillet and a second shape of a second fillet. In some embodiments, the second thickness is measured between a third tangency and a fourth tangency, and a third location of the third tangency and a fourth location of the fourth tangency are based at least in part on the first shape of the first fillet and a second shape of the second fillet.

### BRIEF DESCRIPTION OF THE DRAWINGS

The present disclosure is illustrated by way of example and not limited in the accompanying figures in which like reference numerals indicate similar elements.

FIGS. 1A-1B illustrate components and devices associated with a thrust reverser system in accordance with the prior art.

FIG. 2 illustrates a leading edge of a cascade vane in accordance with the prior art.

FIGS. 3-8 illustrate leading edges of cascade vanes in accordance with aspects of this disclosure.

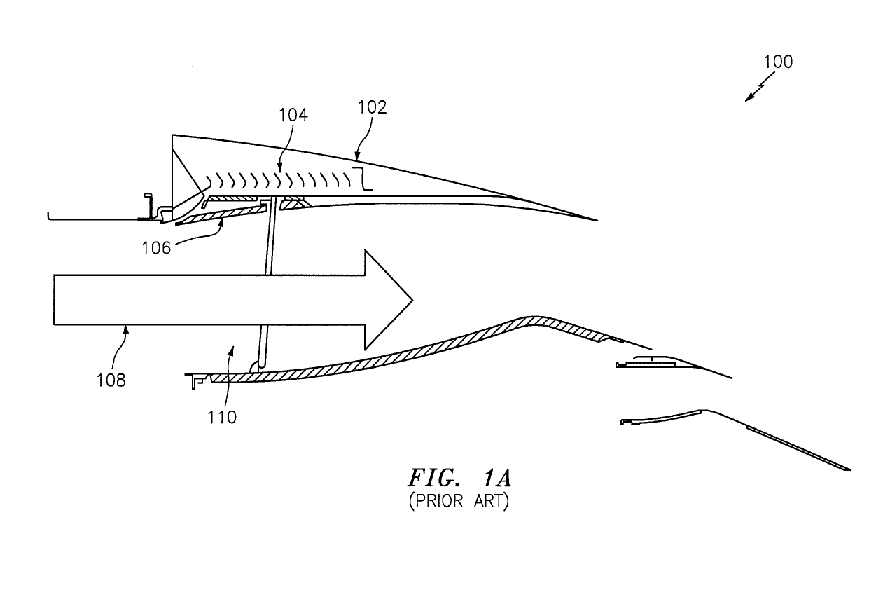

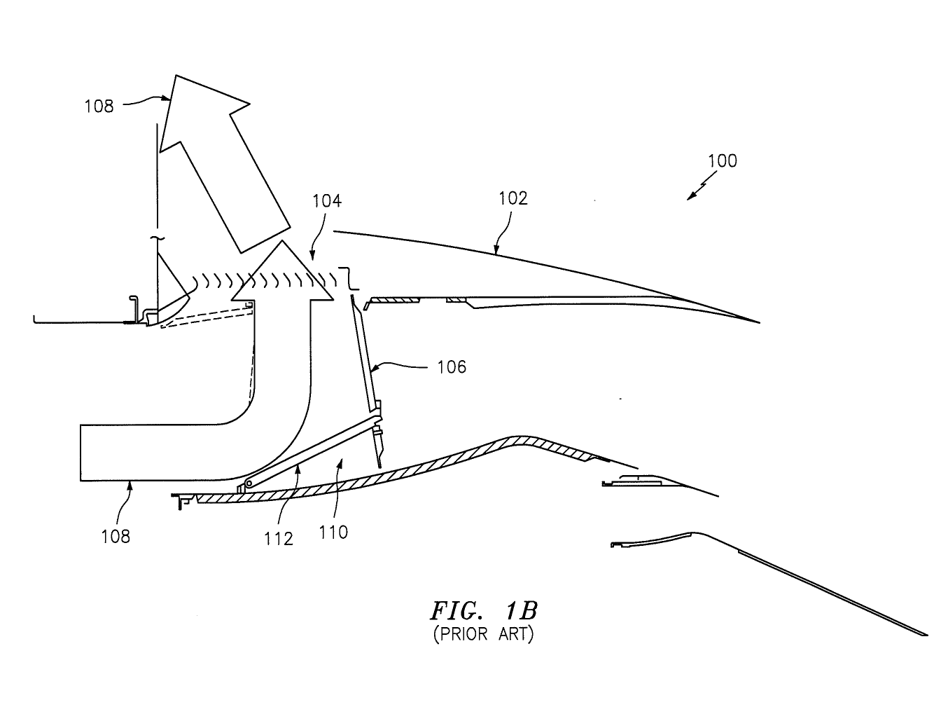

### DETAILED DESCRIPTION

It is noted that various connections are set forth between elements in the following description and in the drawings (the contents of which are included in this disclosure by way of reference). It is noted that these connections are general and, unless specified otherwise, may be direct or indirect and that this specification is not intended to be limiting in this respect. A coupling between two or more entities may refer to a direct connection or an indirect connection. An indirect connection may incorporate one or more intervening entities.

In accordance with various aspects of the disclosure, techniques are described for designing and implementing a thrust reverser for a nacelle of an aircraft. The techniques may be implemented as one or more systems, apparatuses, or methods. In some embodiments, a profile of a leading edge of a cascade vane may be designed to maximize/enhance fluid flow, such as for example a bypass fan flow. As used herein, the phrase “leading edge” in relation to a cascade vane refers to a portion of the cascade vane that initially interfaces/contacts the fluid flow.

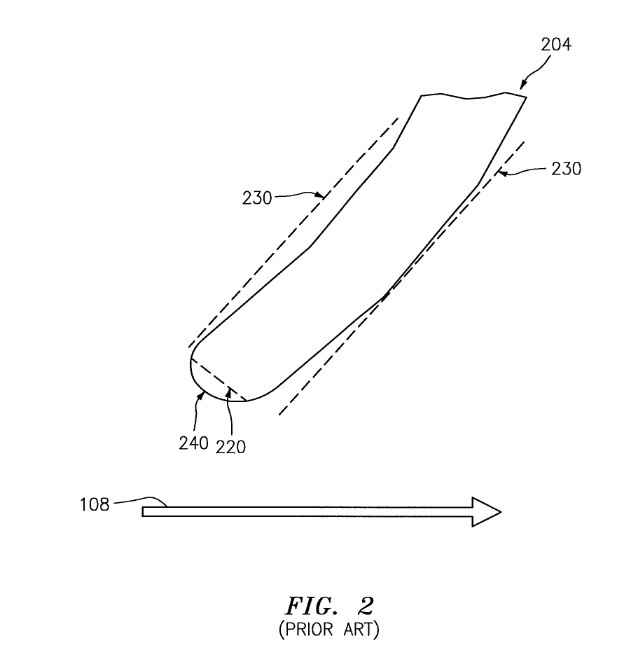

Referring to FIG. 2, a leading edge 204 of a cascade vane (e.g. cascade vane 104) in accordance with the prior art is shown, with the bypass fan flow 108 superimposed for reference purposes. The profile of the leading edge 204 may be characterized by a thickness 220. This thickness 220 is substantially maintained over the length of the leading edge 204 of the cascade vane, where the length is generally represented in FIG. 2 via reference characters 230. At the tip/end 240 of the leading edge 204 that abuts or is proximate to the flow 108, the leading edge 204 may be smoothed/rounded. The smoothing/rounding may be performed by a technician/machinist, but might not adhere to any particular standard or specification. In other words, the smoothing/rounding may be performed based on a qualitative basis (as opposed to a quantitative basis) and acceptance of the cascade vane for use on a nacelle may be based on the technician's experience.

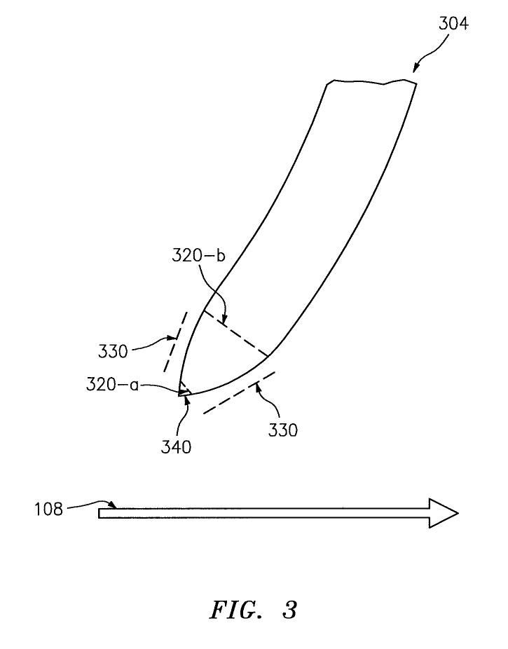

In contrast to the leading edge 204 of FIG. 2, FIG. 3 illustrates a cascade vane leading edge 304 in accordance with aspects of this disclosure. Unlike the substantially uniform thickness 220 of FIG. 2, the leading edge 304 of FIG. 3 may be associated with thicknesses 320-a and 320-b. Thickness 320-a may be substantially located/measured at the tip/end 340 of the leading edge 304 that abuts or is proximate to the flow 108 and thickness 320-b may be located/measured further away from the flow 108. Thickness 320-a may be different from (e.g., smaller than) thickness 320-b, such that the cascade vane leading edge 304 includes a taper/tapered profile (or more generally, a blended profile) over a distance/region 330 between the thicknesses 320-a and 320-b. In some embodiments, the distance 330 may be approximately equal to 0.25 inches (6.35 millimeters). In some embodiments, the distance 330 may be less than the thickness 320-b.

The inclusion of the taper/distance 330 in connection with the leading edge 304 may provide for an increase in thrust reverser performance relative to the leading edge 204. For example, in some instances a 0.08% increase in terms of reversed thrust may be obtained.

Assuming that the thickness 320-b is approximately equal to the thickness 220, the thickness 320-a may be smaller than the thickness 220. For example, the thickness 320-a may be between 15% and 80% of the thickness 220. This reduction in the thickness 320-a (relative to the thickness 220) may provide for a greater tolerance in terms of an inflow angle of the flow 108 with respect to the leading edge 304 (e.g., the tip/end 340 of the leading edge 304). In other words, the leading edge 304 may be less susceptible to aerodynamic loses due to variations in the flow 108 when compared to the leading edge 204 in terms of thrust reverser performance.

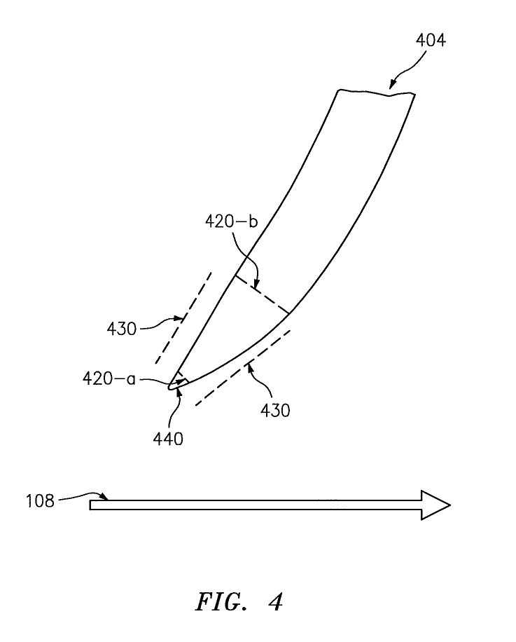

FIG. 4 illustrates a cascade vane leading edge 404. The leading edge 404 of FIG. 4 may be associated with thicknesses 420-a and 420-b. Thickness 420-a may be substantially located/measured/specified at the tip/end 440 of the leading edge 404 that abuts or is proximate to the flow 108 and thickness 420-b may be located/measured/specified further away from the flow 108. Thickness 420-a may be different from (e.g., smaller than) thickness 420-b, such that a taper distance/region 430 may be established between the thicknesses 420-a and 420-b.

In terms of differences between the leading edge 404 and the leading edge 304, the taper distance/region 430 may be longer or of a greater value than the distance 330. In some embodiments, the distance 430 may be approximately equal to 0.50 inches (12.7 millimeters). In some embodiments, such as for example in embodiments where the thickness 420-b is approximately equal to the thickness 220 or the thickness 320-b, the distance 430 may be greater than the thickness 420-b and less than two times the thickness 420-b. The use of the leading edge 404/distance 430 may provide for an increase in terms of reversed thrust relative to the leading edge 204. For example, an increase of 0.79% may be obtained.

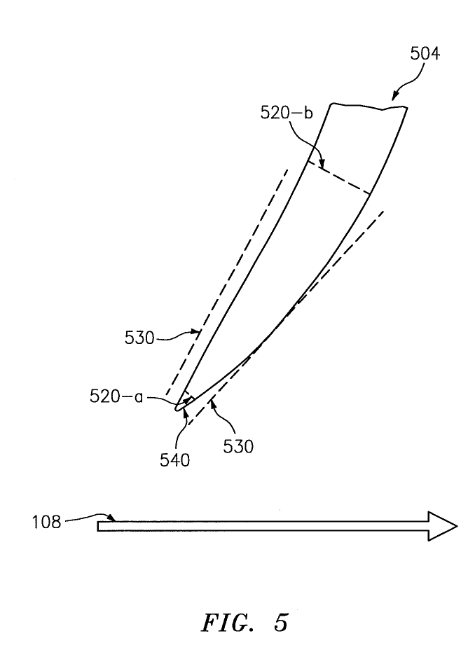

FIG. 5 illustrates a cascade vane leading edge 504. The leading edge 504 of FIG. 5 may be associated with thicknesses 520-a and 520-b. Thickness 520-a may be substantially located/measured/specified at the tip/end 540 of the leading edge 504 that abuts or is proximate to the flow 108 and thickness 520-b may be located/measured/specified further away from the flow 108. Thickness 520-a may be different from (e.g., smaller than) thickness 520-b, such that a taper distance/region 530 may be established between the thicknesses 520-a and 520-b.

In terms of differences between the leading edge 504 and the leading edge 404, the taper distance/region 530 may be longer or of a greater value than the distance 430. In some embodiments, the distance 530 may be approximately equal to 0.75 inches (19.05 millimeters). In some embodiments, such as for example in embodiments where the thickness 520-b is approximately equal to the thickness 220 or the thickness 320-b, the distance 530 may be greater than two times the thickness 520-b. The use of the leading edge 504/distance 530 may provide for an increase in terms of reversed thrust relative to the leading edge 204. For example, an increase of 1.98% may be obtained.

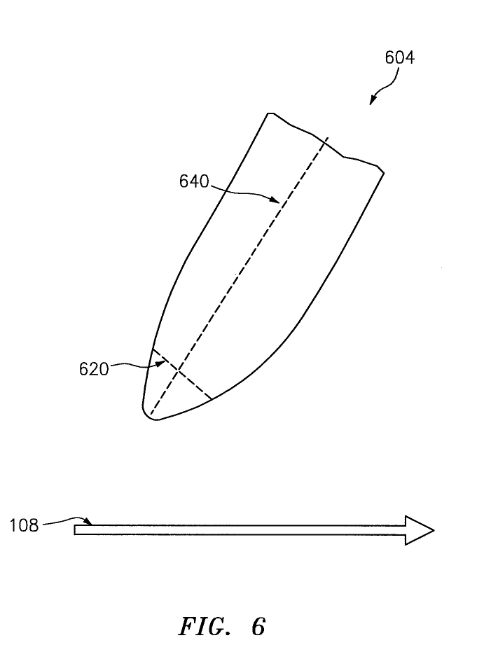

Referring now to FIG. 6, a leading edge 604 is shown. The leading edge 604 may correspond to one or more of the leading edges 304, 404, or 504. FIG. 6 provides a closer view of a thickness 620, which may correspond to one or more of the thicknesses 320-a, 420-a, or 520-a. For purposes of illustration, a reference line 640 is shown as bisecting the vane of FIG. 6 in a lengthwise direction/orientation. The leading edge thickness 620 may be measured as a distance between (1) the most proximate point of the leading edge 604 to the flow 108 and (2) a point along the bisecting line 640.

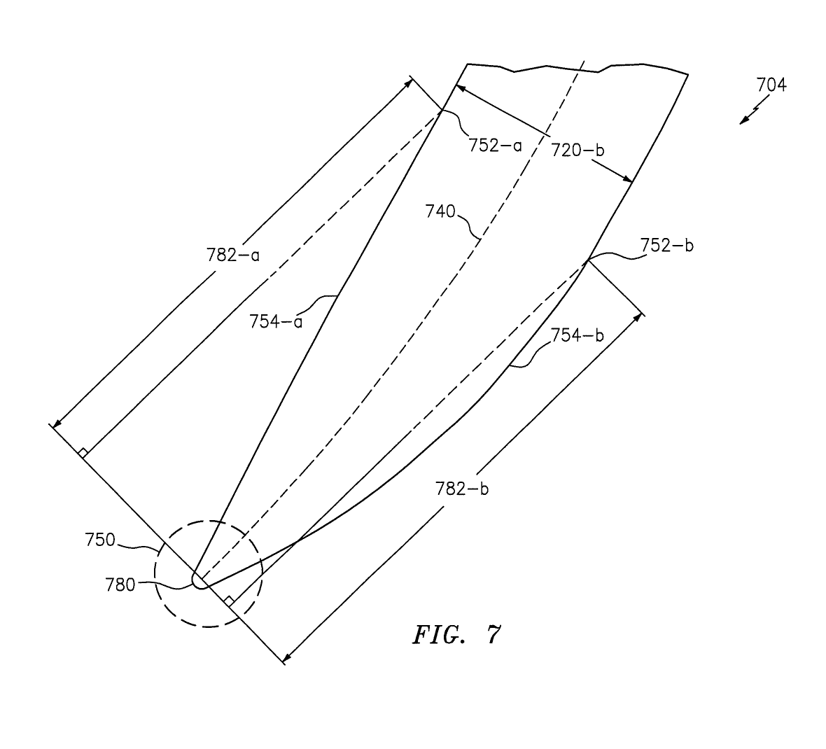

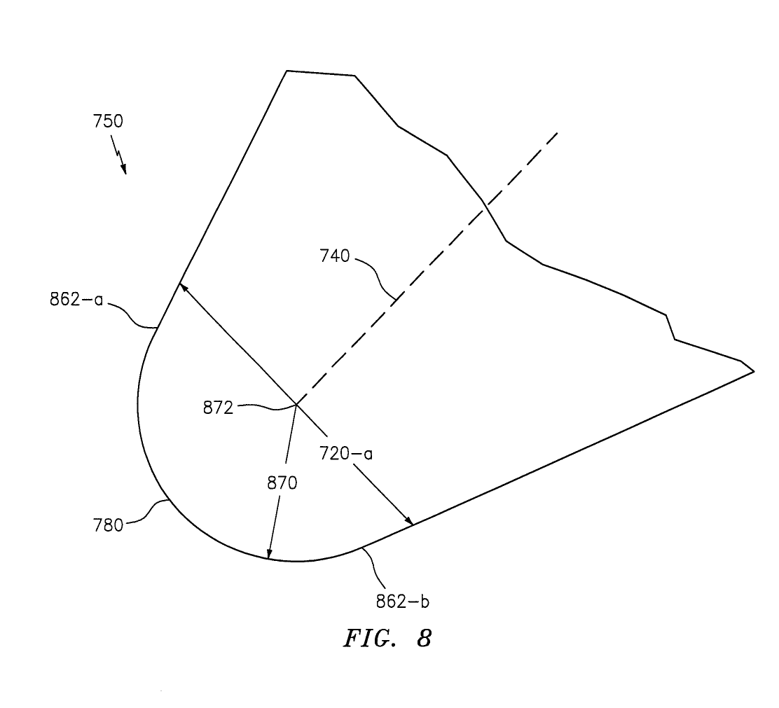

The various thicknesses and taper/blend distances described above in connection with the exemplary embodiments of FIGS. 3-6 may be expressed with additional specificity when taking into account additional features of a leading edge. FIGS. 7-8 diagrammatically illustrate a leading edge 704 in accordance with one or more aspects of the disclosure and provide for such additional specificity.

The leading edge 704 is shown as having an associated thickness 720-b. The thickness 720-b may correspond to one or more of the thicknesses 320-b, 420-b, or 520-b. Substantially perpendicular to the (measurement of the) thickness 720-b shown in FIG. 7 is a vane bisection line 740 (that may be analogous to, or correspond to, the bisection line 640 of FIG. 6) that terminates at a tip/end 780 of the leading edge 704.

While not explicitly shown or drawn as such in FIG. 7, in some embodiments or instances the thickness 720-b may be based on, and may be defined between, a first or inner tangency 752-a and a second or outer tangency 752-b. The endpoints associated with the measurement of the thickness 720-b may substantially coincide with the locations of the tangencies 752-a and 752-b

The locations of the tangencies 752-a and 752-b, in turn, may be based on a shape (e.g., a curvature) associated with the leading edge 704. For example, the locations of the tangencies 752-a and 752-b may be based at least in part on a shape associated with a first or inner fillet 754-a and a second or outer fillet 754-b.

Reference is now made to FIG. 8, which illustrates in greater detail the portion of FIG. 7 identified by the dashed/labeled circle 750. As shown in FIG. 8, a first or inner tangency 862-a and a second or outer tangency 862-b may be defined/located. The tangencies 862-a and 862-b may correspond to a transition point from the fillets 754-a and 754-b, respectively, to the tip 780. Much like the tangencies 752-a and 752-b, the location of the tangencies 862-a and 862-b may be based on a shape/profile associated with the leading edge 704, such as for example the fillet 754-a and the fillet 754-b, respectively.

In transitioning from the tangencies 862-a and 862-b towards the tip 780, a radius 870 may be defined/established. The origin 872 of the radius 870 may be coincident with the vane bisection line 740 as shown. Perpendicular (or substantially perpendicular) to the vane bisection line 740 at the location (or approximate location) of the tangencies 862-a and 862-b and between the tangencies 862-a and 862-b a thickness 720-a may be located/measured/specified.

The thickness 720-a may be located/measured/specified at a short distance from the tip 780 (relative to the location/measurement/specification of the thickness 720-b). The thickness 720-a may correspond to one or more of the thicknesses 320-a, 420-a, or 520-a.

Referring back to FIG. 7, a first or inner edge taper length 782-a and a second or outer edge taper length 782-b are shown. The taper lengths 782-a and 782-b may be specified relative to the tangencies 752-a and 752-b, respectively, and the origin 872.

Technical effects and benefits of this disclosure include an ability to maximize/increase the output of a thrust reverser system for a given unit of area. In doing so, a size/dimension of the thrust reverser system may be reduced/minimized for the same thrust reverse output, thereby leading to savings in terms of weight and output.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one of ordinary skill in the art will appreciate that the steps described in conjunction with the illustrative figures may be performed in other than the recited order, and that one or more steps illustrated may be optional in accordance with aspects of the disclosure. One or more features described in connection with a first embodiment may be combined with one or more features of one or more additional embodiments.

We claim:

1. A thrust reverser system for an aircraft, comprising:
a cascade vane having a first associated thickness and a second associated thickness,
wherein the first thickness is substantially located at an end of the cascade vane that is proximate to a bypass fan flow, and
wherein the first thickness is different from the second thickness such that the cascade vane includes a blended profile between the first thickness and the second thickness.

2. The thrust reverser system of claim 1, wherein a distance of the blended profile is less than the second thickness.

3. The thrust reverser system of claim 1, wherein a distance of the blended profile is greater than the second thickness and less than two times the second thickness.

4. The thrust reverser system of claim 1, wherein a distance of the blended profile is greater than two times the second thickness.

5. The thrust reverser system of claim 1, wherein the second thickness is located further from the bypass fan flow than the first thickness.

6. The thrust reverser system of claim 1, wherein the first thickness is smaller than the second thickness.

7. A cascade vane for an aircraft, comprising:
a leading edge that is configured to interface to a fluid flow,
wherein the leading edge is associated with a first thickness that is proximate to the fluid flow, and
wherein the leading edge is associated with a second thickness that is further from the fluid flow than the first thickness, and
wherein the first thickness is smaller than the second thickness such that the leading edge includes a distance associated with a blended profile between the first thickness and the second thickness.

8. The cascade vane of claim 7, wherein the fluid flow comprises a bypass fan flow.

9. The cascade vane of claim 7, wherein the first thickness is measured between a first tangency and a second tangency, and wherein a first location of the first tangency and a second location of the second tangency are based at least in part on a first shape of a first fillet and a second shape of a second fillet.

10. The cascade vane of claim 9, wherein the second thickness is measured between a third tangency and a fourth tangency, and wherein a third location of the third tangency and a fourth location of the fourth tangency are based at least in part on the first shape of the first fillet and a second shape of the second fillet.
